(19) United States
(12) Patent Application Publication
(10) Pub. No.: US 2015/0015422 A1
(43) Pub. Date: Jan. 15, 2015

(54) STANDBY FLIGHT DISPLAY SYSTEM

(71) Applicant: Gulfstream Aerospace Corporation, Savannah, GA (US)

(72) Inventor: Charles Michaels, Savannah, GA (US)

(21) Appl. No.: 13/941,055

(22) Filed: Jul. 12, 2013

(51) Int. Cl. B64D 43/00

(52) U.S. Cl. CPC B64D 43/00
USPC 340/973

(57) ABSTRACT

A standby flight display system for use on an aircraft is disclosed herein. The aircraft has a primary flight display system that is configured to display a first image on a primary flight display screen. The standby flight display system includes a subsystem configured to determine a dynamic state of the aircraft. The standby flight display system further includes an image generator. The standby flight display system still further includes a processing unit. The subsystem, the image generator, and the processing unit are each independent of the primary flight display system. The processing unit is communicatively coupled with the subsystem and with the image generator and is configured to receive information from the subsystem relating to the dynamic state of the aircraft and to control the image generator to generate a second image overlaying the first image on the primary flight display screen.

### TECHNICAL FIELD

The present invention generally relates to aircraft and more particularly relates to a standby flight display system for backing up a primary flight display system on an aircraft.

### BACKGROUND

Modern passenger aircraft commonly include a primary flight display system that includes a primary flight display screen that is positioned in a flight deck at a location where it can present information to a member of the flight crew (e.g., pilot, co-pilot). Among other items, a primary flight display system will display information to the pilot relating to the dynamic state of the aircraft while the aircraft is in flight. Such information includes at least the aircraft's altitude, attitude, heading, and airspeed.

Because the aircraft's altitude, attitude, heading, and airspeed are considered critical information, current regulations promulgated by the Federal Aviation Administration and by some foreign counterparts require that there be a redundant display system having a display screen mounted in the flight deck at a location that is visible to all pilots and that redundantly displays this critical information. Such a redundant system will enable a pilot/co-pilot to have continued access to this critical information even in circumstances where there has been a failure of the primary flight display system. Furthermore, this redundant display system derives the altitude, attitude, heading, and airspeed information from a source(s) that differs from the source(s) used by the primary flight display system. Thus, it is not sufficient to simply provide a redundant display screen in the flight deck. Rather, there must be a redundant subsystem(s) that is/are capable of detecting/determining the dynamic state of the aircraft and a redundant processor for processing the data generated by the subsystem(s).

In view of these regulations, modern aircraft include a redundant display system known as a standby flight display system. Conventional standby flight display systems include a standby flight display screen, at least one subsystem, and a processing unit. The standby flight display screen is mounted in the flight deck in a location visible to all pilots. The subsystem(s) is/are configured to ascertain various dynamic conditions of the aircraft. The processing unit receives and processes information provided by the subsystem(s) and controls the standby flight display screen to display the aircraft's altitude, attitude, heading, and airspeed.

While the above described conventional standby flight display system is adequate, there is room for improvement. The use of a separate and distinct standby flight display screen in the flight deck consumes valuable space on an already crowded instrument panel. Further, the presence of a secondary monitor in the aircraft adds weight and cost to the aircraft. In addition, there is added weight and cost arising out of the wires, cables, controllers, and other related equipment that is needed to support a separate standby flight display screen. In summary, the use of a redundant display screen in a standby flight display system adds weight, cost, and complexity to the aircraft.

Accordingly, it is desirable to provide a standby flight display system that enables an aircrew member to continue to have access to an aircraft's altitude, attitude, heading and airspeed information in the event of a failure of the aircraft's primary flight display system while also reducing the aircraft's weight, cost and complexity. Furthermore, other desirable features and characteristics will become apparent from the subsequent summary and detailed description and the appended claims, taken in conjunction with the accompanying drawings and the foregoing technical field and background.

### BRIEF SUMMARY

A standby flight display system is disclosed herein for use on an aircraft. The aircraft includes a primary flight display system that is configured to display a first image on a primary flight display screen. Exemplary embodiments of the standby flight display system of the present disclosure include the features set forth in the following paragraphs.

In a first non-limiting embodiment, the standby flight display system includes, but is not limited to, a subsystem that is configured to determine a dynamic state of the aircraft. The subsystem is independent of the primary flight display system. The standby flight display system further includes, but is not limited to, an image generator that is independent of the primary flight display system. The standby flight display system still further includes, but is not limited to, a processing unit that is independent of the primary flight display system. The processing unit is communicatively coupled with the subsystem and with the image generator. The processing unit is configured to receive information from the subsystem relating to the dynamic state of the aircraft and to control the image generator to generate a second image on the primary flight display screen relating to the dynamic state of the aircraft, the second image overlaying the first image.

In another non-limiting embodiment, the standby flight display system includes, but is not limited to, a subsystem that is configured to determine a dynamic state of the aircraft. The subsystem is independent of the primary flight display system. The standby flight display system further includes, but is not limited to, an image generator that is independent of the primary flight display system. The standby flight display system still further includes, but is not limited to, a processing unit that is independent of the primary flight display system. The processing unit includes, but is not limited to, a data processor and a graphics processor. The data processor and the graphics processor are communicatively coupled with one another. The data processor is further communicatively coupled with the subsystem and is configured to receive information from the subsystem relating to the dynamic state of the aircraft, to generate a signal based on the information, and to provide the signal to the graphics processor. The graphics processor is configured to utilize the signal to control the image generator to generate a second image on the primary flight display screen relating to the dynamic state of the aircraft, the second image overlaying the first image.

In yet another non-limiting embodiment, the standby flight display system includes, but is not limited to, a subsystem that is configured to determine a dynamic state of the aircraft. The subsystem is independent of the primary flight display system. The standby flight display system further includes, but is not limited to, an image generator that is independent of the primary flight display system. The standby flight display system still further includes, but is not limited to, a processing unit that is communicatively coupled with the subsystem, with the image generator, and with the primary flight display system. The processing unit is configured to receive information from the subsystem relating to the dynamic state of the aircraft and to control the image generator to generate a second image on the primary flight display screen relating to the dynamic state of the aircraft, the second image overlaying the first image. The processing unit is further configured to receive information from the primary flight display system relating to the first image and to utilize the information to align the second image with the first image.

### BRIEF DESCRIPTION OF THE DRAWINGS

The present invention will hereinafter be described in conjunction with the following drawing figures, wherein like numerals denote like elements, and

FIG. 1 is a block diagram illustrating a non-limiting embodiment of a standby flight display system made in accordance with the teachings of the present disclosure;

FIG. 2 is a schematic view illustrating an aircraft flight deck equipped with a rear-projection display screen receiving an image from a projector associated with a primary flight display system and also an image from a projector associated with the standby flight display system of FIG. 1;

FIG. 3 is a view that presents an image generated by a primary flight display system, another image generated by the standby flight display system of FIG. 1, and a third image comprised of the first two images overlayed on top of one another;

FIG. 4 is a block diagram illustrating another non-limiting embodiment of a standby flight display system made in accordance with the teachings of the present disclosure; and

FIG. 5 is a block diagram illustrating yet another non-limiting embodiment of a standby flight display system made in accordance with the teachings of the present disclosure.

### DETAILED DESCRIPTION

The following detailed description is merely exemplary in nature and is not intended to limit the invention or the application and uses of the invention. Furthermore, there is no intention to be bound by any theory presented in the preceding background or the following detailed description.

An improved standby flight display system is disclosed herein. The standby flight display system of the present disclosure is configured for use on an aircraft having a primary flight display system that includes a primary flight display screen on which the primary flight display system displays information relating to a dynamic condition of the aircraft, among other information. The standby flight display system includes one or more subsystems that are configured to detect and/or determine a dynamic condition of the aircraft. Examples of such subsystems include, but are not limited to, Air Data Systems, Attitude Heading Reference Systems, and navigation radios. Such subsystems may include sensors such as, but not limited to, pitot tubes, accelerometers, gyroscopes, and antennas. The standby flight display system further incudes a processing unit that is communicatively coupled with the subsystem(s). The subsystem(s) is/are configured to provide information relating to the dynamic condition of the aircraft to the processing unit. The standby flight display system further includes an image generator that is communicatively coupled with the processing unit. The image generator may comprise any device that is capable of generating a graphical image on a display screen. The processing unit is configured to use the information relating to the dynamic condition of the aircraft to control the image generator to generate an image for display on the primary flight display screen. The image generated by the image generator will be overlaid on top of the image generated by the primary flight display. The image generated by the standby flight display system may be substantially identical to the image generated by the primary flight display system and may be substantially aligned therewith such that the two images appear as a single image.

In accordance with the present disclosure, if a failure of the primary flight display system occurs during a flight, and if such failure leads to a cessation of the image displayed by the primary flight display system, the substantially identical image generated by the standby flight display system will remain displayed in substantially the same location. Thus, the standby fight display system of the present disclosure eliminates the need for an aircrew member to look elsewhere to obtain the information relating to the dynamic condition of the aircraft. The standby flight display system of the present disclosure further eliminates the need for a second monitor/display screen in the aircraft's flight deck, thus reducing weight, cost, and complexity, and freeing up a sizable amount of surface area on the aircrafts' instrument panel.

A greater understanding of the standby flight display system described above may be obtained through a review of the illustrations accompanying this application together with a review of the detailed description that follows.

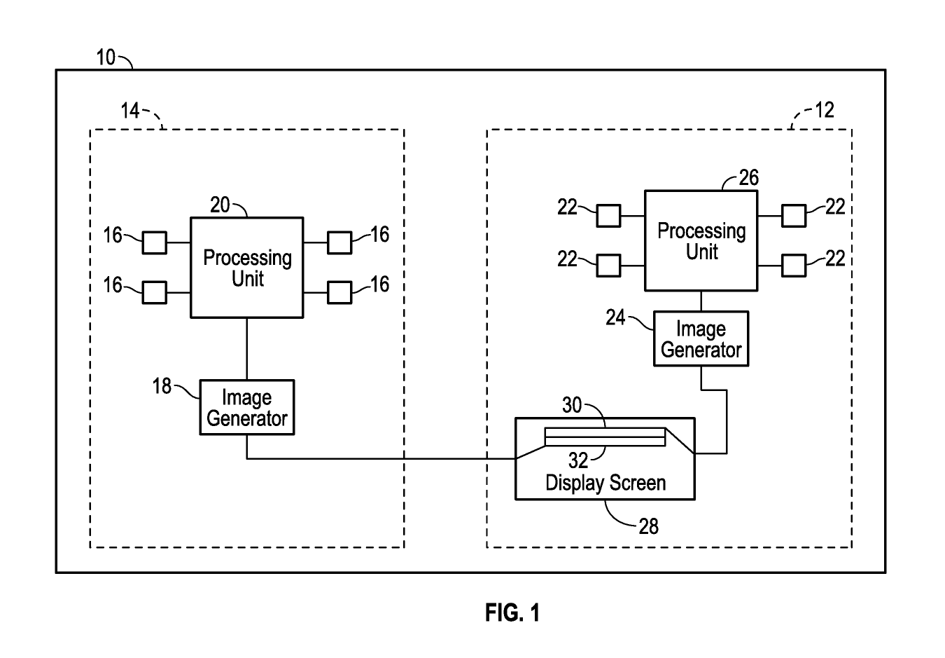

FIG. 1 is block diagram illustrating an aircraft 10 equipped with a primary flight display system 12 and a non-limiting embodiment of a standby flight display system 14 made in accordance with the teachings of the present disclosure. Aircraft 10 may be any type of aircraft including, but not limited to a propeller driven aircraft, a jet powered aircraft, a rotor driven aircraft, and a lighter-than-air aircraft. Additionally, the aircraft employing standby flight display system 14 may serve any purpose including, but not limited to service as a commercial airliner, a privately owned/corporate aircraft, a military aircraft, a cargo aircraft, or any other aircraft now known, or hereafter developed. Furthermore, standby flight display system 14 is not limited to use only with aircraft but rather may be utilized on any other type of vehicle, including, but not limited to land-based vehicles, watercraft and spacecraft.

Standby flight display system 14 includes, but is not limited to, a plurality of subsystems 16, an image generator 18, and a processing unit 20. Similarly, primary flight display system 12 includes a plurality of subsystems 22, an image generator 24 and a processing unit 26. For the purposes of ensuring that a pilot or other aircrew member has continuous access to critical data, the components just listed for primary flight display system 12 and the components just listed for standby fight display system 14 are not connected with one another in any way. Rather, the components of each system are independent of the corresponding component from the other system and are functionally redundant. Thus, if one of the subsystems 22 of primary flight display system 12 fails, the ability of the standby flight display system 14 to continue providing critical information to the pilot or other aircrew member is not impacted by such failure.

Subsystem 16 may comprise any device, mechanism or system that is configured to ascertain a dynamic state of aircraft 10. The dynamic state of aircraft 10 includes, but is not limited to, an attitude, an altitude, a heading, and an airspeed of aircraft 10. Some exemplary embodiments of systems/devices suitable to serve as subsystem 16 include, but are not limited to, an Air Data System, an Altitude Heading Reference System, an Inertial Navigation System, a GPS Navigation System, and a navigation radio (e.g., TACAN, VORTAC, VHF Omniradio (VOR), Distance Measuring Equipment (DME), and the like), all of which are known in the art.

Image generator 18 may comprise any device suitable for generating an image on display screen 28. Image generator 18 may be configured in accordance with any of several different display technologies. For example, and without limitation, image generator 18 may be configured to generate an image on a cathode ray tube display, a plasma screen display, a liquid crystal display, a light emitting diode display, and a display compatible for use with projectors such as a digital light projector, as well as any other type of display technology. In the embodiment illustrated in FIG. 1, image generator 18 comprises a digital light projector suitable for projecting an image on a compatible projection screen.

In the illustrated embodiment, processing unit 20 comprises a single processor. In other embodiments, processing unit 20 may comprise a plurality of processors having redundant capabilities working in concert, or a plurality of processors having complementary capabilities working in concert, or combinations thereof. As used herein the term “processor” shall mean any type of computer, controller, micro-controller, circuitry, chipset, computer system, or microprocessor that is configured to perform algorithms, to execute software applications, to execute sub-routines and/or to be loaded with and to execute any other type of computer program.

Processing unit 20 is communicatively coupled with both image generator 18 and with each subsystem 16. Such communicative coupling may be effected through the use of any suitable means of transmission including both wired and wireless connections. For example, each component may be physically connected to processing unit 20 via a coaxial cable or via any other type of wired connection that is effective to convey signals. In the illustrated embodiment, processing unit 20 is directly communicatively coupled with each of the other components. In other embodiments, each component may be communicatively coupled with processing unit 20 indirectly or across a CAN bus. In still other examples, each component may be wirelessly communicatively coupled to processing unit 20. For example, in some embodiments, each component may be coupled with processing unit 20 via a Bluetooth connection, a WiFi connection or the like.

Being communicatively coupled provides a pathway for the transmission of signals, commands, instructions, interrogations and other communications between processing unit 20 and each of the other components. Through this communicative coupling, processing unit 20 may control and/or communicate with each of the other components. Each of the other components is configured to interface and engage with processing unit 20. For example, each of the various subsystems 16 is configured to send data/information relating to the dynamic state of aircraft 10 to processing unit 20 as the data/information is collected or determined. Additionally, image generator 18 is configured to receive commands or instructions from processing unit 20 relating to an image or images to be generated by image generator 18. Similarly, processing unit 20 is configured to interact with, coordinate and/or orchestrate the activities of each of the other components of standby flight display system 14.

In the embodiment illustrated in FIG. 1, processing unit 20 is configured to receive the data/information that has been detected/generated by the various subsystems 16 relating to the dynamic state of the aircraft. Processing unit 20 is further configured to process the data/information (e.g., perform calculations) to determine at least the attitude, altitude, heading, and airspeed of aircraft 10 based on the data/information provided by the various subsystems 16. In some embodiments, the subsystems 16 themselves may process the data/information and deliver the results of such processing to processing unit 20. Processing unit 20 is further configured to provide commands to image generator 18 that will cause image generator 18 to generate an image that will graphically convey (either through graphics images, textual images, or combinations thereof) the attitude, altitude, heading, and airspeed of aircraft 10 to a pilot or aircrew member.

In addition to the components listed above as part of the primary flight display system 12, primary flight display system 12 further includes a display screen 28. Primary flight display system 12 is configured to output information to the pilot/aircrew member on display screen 28. In some embodiments, the information relates to at least the attitude, altitude, heading, and airspeed of aircraft 10. To deliver this information to the pilot/aircrew member, primary flight display system 12 is configured to produce an image 30 on display screen 28. Image 30 may include graphical images, textual images, and/or combinations thereof. In an aircraft having multiple display screens 28, primary flight display system 12 may cause substantially identical images 30 to be displayed on each of the multiple display screens 28.

Standby flight display system 14 is also configured to present images on display screen 28. In the illustrated embodiment, image generator 18 is configured to generate an image 32 and is further configured to cause image 32 to be displayed on display screen 28. In the illustrated embodiment, display screen 28 comprises a rear projection screen and image generator 18 and image generator 24 each comprise a digital light projector. In some embodiments, image generator 18 and image generator 24 may be mechanically aligned with one another such that image 30 and image 32 are precisely overlaid on top of one another such that the two images combine to create the appearance of a single image. In other embodiments, processing unit 20 may be configured to cause image generator 18 to focus image 32 in a manner that causes image 32 to align with and precisely overlay image 30. By utilizing a display screen associated with primary flight display system 12 (i.e., display screen 28), standby flight display system 14 excludes a display screen of its own and thereby reduces the cost, complexity, expense, and weight associated with standby flight display system 14. This arrangement provides for a further advantage in that in the event that there is a failure of primary flight display system 12, the pilot/aircrew member viewing the information presented on display screen 28 need not look elsewhere for the information because the same information will be presented at the same location on the same display screen by standby flight display system 14. Thus the failure of primary flight display system 12 will not create an interruption in the presentation of the critical information to the pilot/aircrew member, nor will such a failure require any adjustment in the conduct of flight operations by the pilot or other aircrew member.

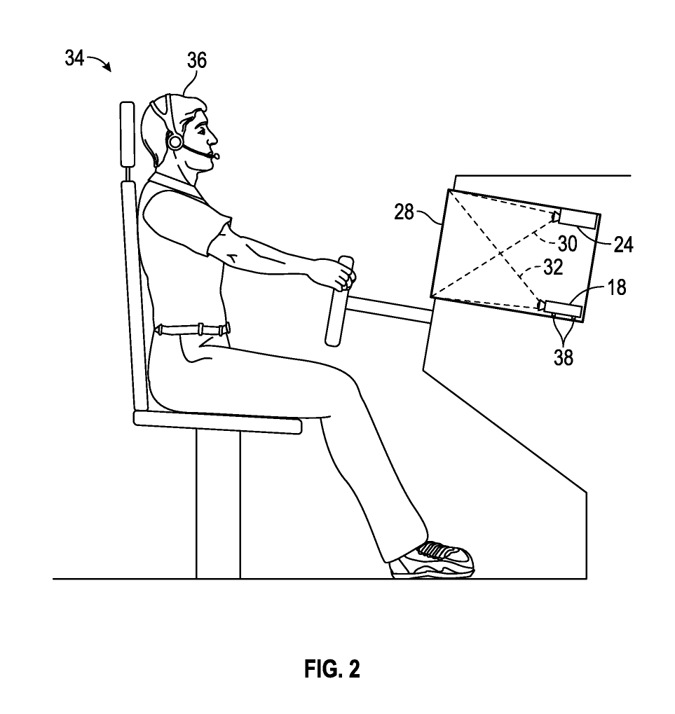

FIG. 2 is a schematic view illustrating a flight deck 34 of an aircraft equipped with the standby flight display system 14 discussed above with respect to FIG. 1. An aircrew member 36 is seated in front of display screen 28. Display screen 28 comprises a rear projection screen. Image generator 18 and image generator 24 are each mounted within a housing associate with display screen 28 and are arranged to project their respective images on a rear portion of display screen 28. As illustrated, image generator 24 projects image 30 on to the rear of display screen 28. Image generator 18 also projects image 32 onto the rear of display screen 28 in a manner that overlays image 30. In the illustrated embodiment, image generator 18 is fitted with adjustable legs 38 that permit an operator to adjust image generator 18 to align image 32 with image 30. In other embodiments, such alignment may be accomplished electronically by processing unit 20 (see FIG. 1), or in any other suitable manner.

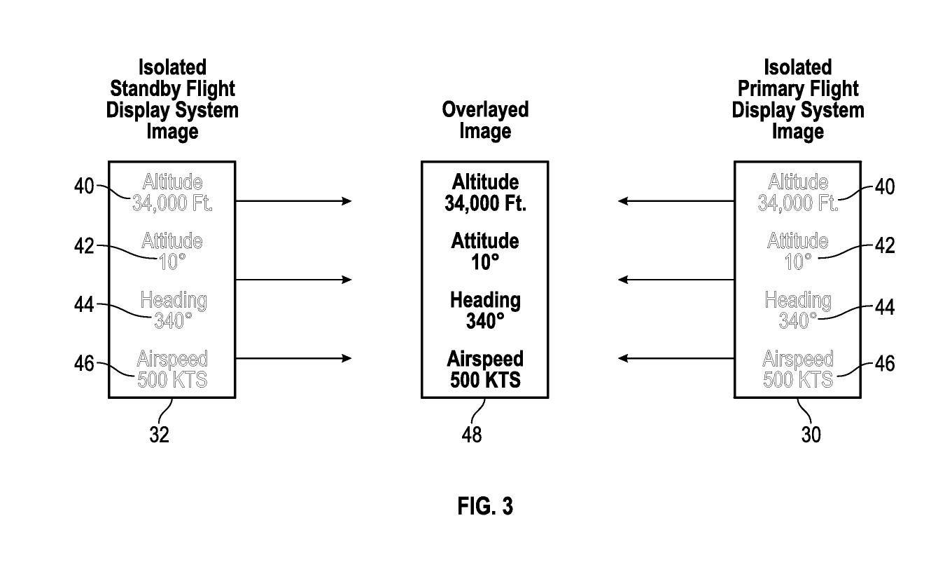

FIG. 3 presents an example of image 30 and image 32 generated by image generator 18 and image generator 24, respectively. As illustrated, image 30 and image 32 are substantially identical. Each image includes information relating to a dynamic state of aircraft 10 (see FIG. 1) including altitude information 40, attitude information 42, heading information 44, and airspeed information 46. In other embodiments, additional information may also be displayed.

When image 32 is overlaid onto image 30, a combined image 48 is formed. Each image (i.e., image 30 and image 32), when taken in isolation, is less bright than combined image 48. Thus, if there is a failure of primary flight display system 12 (see FIG. 1), then the brightness of the image will diminish, thereby alerting the pilot/aircrew member to the malfunction.

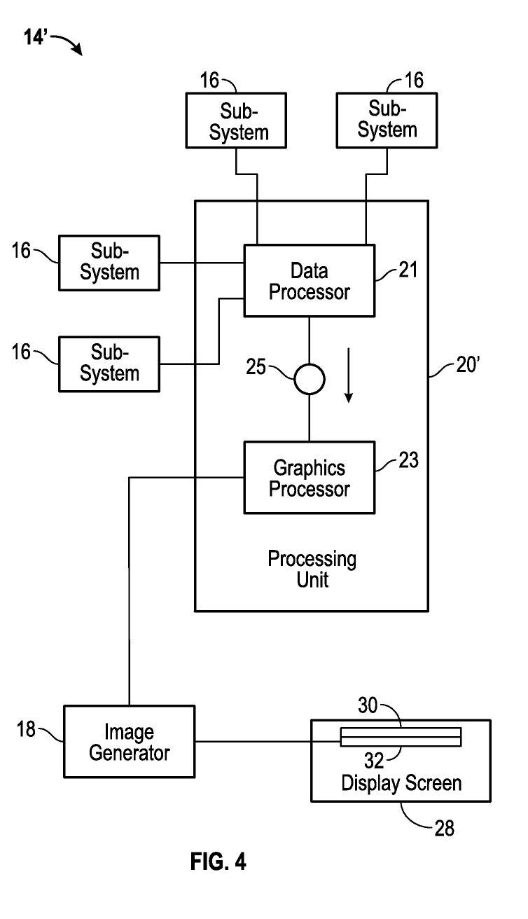

FIG. 4 is a block diagram illustrating an alternate embodiment of a standby flight display system 14′. With continuing reference to FIG. 1, standby flight display system 14′ is nearly identical to standby flight display system 14, the only difference being that while standby flight display system 14 employed a single processor (i.e., processing unit 20), standby flight display system 14′ includes a processing unit 20′ that includes two processors, a data processor 21 and a graphics processor 23, that are communicatively coupled with one another.

As illustrated, the various subsystems 16 are each communicatively coupled with data processor 21 and provide their respective data/information directly to data processor 21. Data processor 21 is configured to receive the data/information from each of the subsystems 16. Data processor 21 is further configured to perform calculations and to execute algorithms that convert the data/information received from each of the subsystems into a signal 25 that is compatible with, and interpretable by, graphics processor 23. Data processor 21 is further configured to deliver signal 25 to graphics processor 23. In some embodiments, data processor 21 may continuously generate and provide signal 25 to graphics processor 23 such that graphics processor 23 receives a data stream from data processor 21.

In the illustrated embodiment, graphics processor 23 is communicatively coupled with image generator 18. Graphics processor 23 is configured to receive signal 25 from data processor 21 and to utilize signal 25 to generate instructions that are compatible with image generator 18. Graphics processor 23 sends the instructions to image generator 18 and image generator, in turn, utilizes the instructions received from graphics processor 23 to generate image 32.

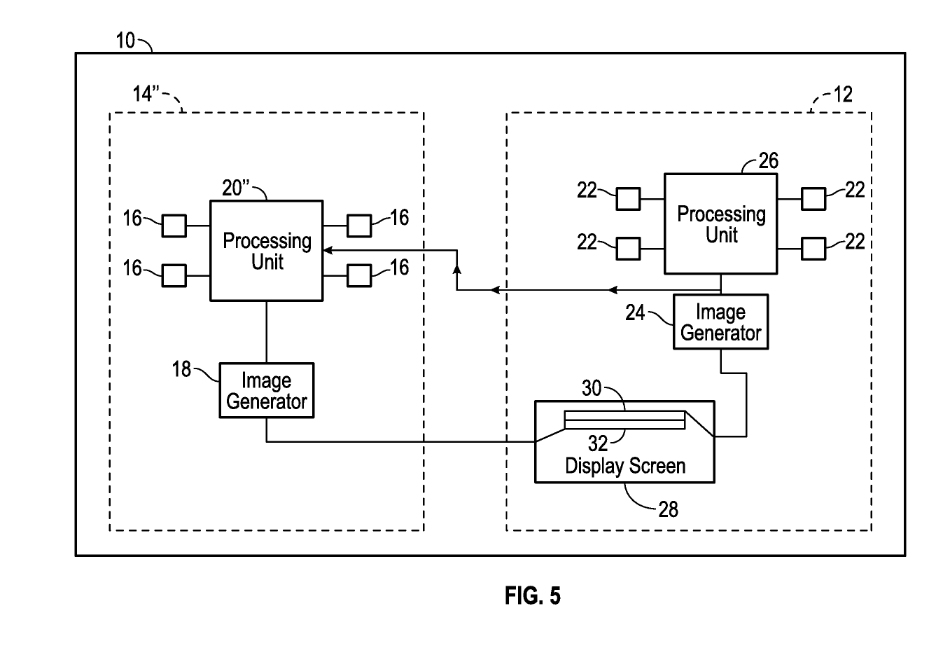

FIG. 5 is a block diagram illustrating another alternate embodiment of a standby flight display system 14″. With continuing reference to FIG. 1, standby flight display system 14″ is nearly identical to standby flight display system 14, the only difference being that while processing unit 20 of standby flight display system 14 is completely independent of primary flight display system 12, in standby flight display system 14″, processing unit 20″ is communicatively coupled with processing unit 26 of primary flight display system 12. While this communicative coupling is illustrated as being a direct wired connection, it should be understood that any other configuration effective to deliver information from processing unit 26 to processing unit 20″ may also be employed without departing from the teachings of the present disclosure. For example, the two processing units may be wirelessly communicatively coupled with one another.

Processing unit 20″ is configured to receive information from processing unit 26 relating to image 30. In some embodiments, the information may relate to instructions that processing unit 26 have given to image generator 24 regarding how one or more specific pixels on display screen 28 are to be illuminated. Processing unit 20″ is configured to utilize this information to align image 32 on display screen 28 with image 30. In other embodiments, any other information that permits processing unit 20″ to align image 32 with image 30 may be obtained by processing unit 20″ from processing unit 26.

While at least one exemplary embodiment has been presented in the foregoing detailed description of the disclosure, it should be appreciated that a vast number of variations exist. It should also be appreciated that the exemplary embodiment or exemplary embodiments are only examples, and are not intended to limit the scope, applicability, or configuration of the invention in any way. Rather, the foregoing detailed description will provide those skilled in the art with a convenient road map for implementing an exemplary embodiment of the invention. It being understood that various changes may be made in the function and arrangement of elements described in an exemplary embodiment without departing from the scope of the disclosure as set forth in the appended claims.

What is claimed is:

1. A standby flight display system for use on an aircraft, the aircraft having a primary flight display system configured to display a first image on a primary flight display screen, the standby flight display system comprising:
a subsystem configured to determine a dynamic state of the aircraft, the subsystem being independent of the primary flight display system;
an image generator independent of the primary flight display system; and
a processing unit independent of the primary flight display system, the processing unit communicatively coupled with the subsystem and with the image generator, the processing unit configured to receive information from the subsystem relating to the dynamic state of the aircraft and to control the image generator to generate a second image on the primary flight display screen relating to the dynamic state of the aircraft, the second image overlaying the first image.

2. The standby flight display system of claim 1, wherein the second image is substantially identical to the first image.

3. The standby flight display system of claim 2, wherein the second image is substantially aligned with the first image.

4. The standby flight display system of claim 3, wherein the processing unit is configured to substantially align the second image with the first image.

5. The standby flight display system of claim 3, wherein the image generator is configured for adjustment to permit alignment of the second image with the first image.

6. The standby flight display system of claim 1, wherein the image generator comprises a projector.

7. The standby flight display system of claim 6, wherein the projector comprises a digital light projector.

8. The standby flight display system of claim 6, wherein the projector is arranged to project the second image on a rear portion of the primary flight display screen.

9. The standby flight display system of claim 1, further comprising a plurality of the subsystems.

10. The standby flight display system of claim 1, wherein the subsystem comprises one of an air data system, an altitude heading reference system, and a navigation radio system.

11. A standby flight display system for use on an aircraft, the aircraft having a primary flight display system configured to display a first image on a primary flight display screen, the standby flight display system comprising:
a subsystem configured to determine a dynamic state of the aircraft, the subsystem being independent of the primary flight display system;
an image generator independent of the primary flight display system; and
a processing unit independent of the primary flight display system, the processing unit including a data processor and a graphics processor, the data processor and the graphics processor communicatively coupled with one another, the data processor further communicatively coupled with the subsystem and configured to receive information from the subsystem relating to the dynamic state of the aircraft, to generate a signal based on the information received from the subsystem, and to provide the signal to the graphics processor, the graphics processor configured to utilize the signal to control the image generator to generate a second image on the primary flight display screen relating to the dynamic state of the aircraft, the second image overlaying the first image.

12. The standby flight display system of claim 11, wherein the second image is substantially identical to the first image.

13. The standby flight display system of claim 12, wherein the second image is substantially aligned with the first image.

14. The standby flight display system of claim 13, wherein the processing unit is configured to substantially align the second image with the first image.

15. The standby flight display system of claim 13, wherein the image generator is configured for adjustment to permit alignment of the second image with the first image.

16. The standby flight display system of claim 11, wherein the image generator comprises a projector.

17. The standby flight display system of claim 16, wherein the projector comprises a digital light projector.

18. The standby flight display system of claim 16, wherein the projector is arranged to project the second image on a rear portion of the primary flight display screen.

19. A standby flight display system for use on an aircraft, the aircraft having a primary flight display system configured to display a first image on a primary flight display screen, the standby flight display system comprising:
a subsystem configured to determine a dynamic state of the aircraft, the subsystem being independent of the primary flight display system;
an image generator independent of the primary flight display system; and
a processing unit communicatively coupled with the subsystem, with the image generator, and with the primary flight display system, the processing unit configured to receive information from the subsystem relating to the dynamic state of the aircraft and to control the image generator to generate a second image on the primary flight display screen relating to the dynamic state of the aircraft, the second image overlaying the first image, and the processing unit further configured to receive information from the primary flight display system relating to the first image and to utilize the information to align the second image with the first image.

20. The standby flight display system of claim 19, wherein the processing unit is configured to substantially align the second image with the first image by aligning a plurality of pixels of the second image with a corresponding plurality of pixels of the first image.
